(19) United States
(12) Patent Application Publication
(10) Pub. No.: US 2021/0183327 A1
(43) Pub. Date: Jun. 17, 2021

(54) DISPLAY PANEL AND DISPLAY DEVICE

(71) Applicant: WUHAN CHINA STAR OPTOELECTRONICS SEMICONDUCTOR DISPLAY TECHNOLOGY CO., LTD., Wuhan (CN)

(72) Inventor: Zesheng CHEN, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/348,152

(22) PCT Filed: Mar. 13, 2019
(86) PCT No.: PCT/CN2019/077971

§ 371 Date: May 8, 2019

(30) Foreign Application Priority Data
Dec. 24, 2018 (CN) 201811579853.X

(51) Int. Cl. G09G 3/36

(52) U.S. Cl. CPC G09G 3/3677; G09G 3/3688

(57) ABSTRACT

The present invention discloses a display panel and a display device. The display panel includes a display area, a non-display area surrounding the display area, multi-level gate driver on array (GOA) circuits, extension lines, multi-level signal scanning lines, an electrical insulation layer, and bridging lines. The extension lines are respectively and correspondingly connected to the signal output ends of the GOA circuits. The multi-level signal scanning lines are disposed on a same layer as the extension lines and disposed in the display area, where each level of signal scanning lines corresponds to one extension line. The electrical insulation layer is covered the signal scanning lines and extension lines. The bridging lines are disposed on the electrical insulation layer. One of the bridging lines is connected between at least one level of signal scanning lines and one of the extension lines corresponding to the signal scanning line.

### FIELD OF INVENTION

The present invention relates to the field of liquid crystal display, and in particular, to a display panel and a display device.

### BACKGROUND OF INVENTION

A narrow-bezel liquid crystal panel is generally a panel having a bezel width less than 1 millimeter (mm). The narrow-bezel liquid crystal panel can achieve a very good visual effect, so that the narrow-bezel liquid crystal panel is a current trend in development of liquid crystal panels.

At present, display devices such as mobile phones and tablet computers are all required to have narrow bezels, to achieve a better appearance effect. A liquid crystal display panel includes a plurality of data lines and a plurality of scanning lines that are disposed by crossing each other. To implement a narrow-bezel display panel, generally, each scanning line is electrically connected to one connection line, and the connection line and the data line are made to have a same extension direction, so that a drive circuit connected to the scanning line and a data drive chip connected to the data line can be disposed at a same side, to enable the display panel to have three narrow bezels. However, in the prior art, in order to electrically connect the connection line with a corresponding scanning line, instead of electrically connecting to another scanning line, generally, a new metal layer needs to be added. The metal layer is patterned, to obtain a required connection line. The connection line is connected to a corresponding scanning line through a via. Because of processes required by adding the metal layer, and patterning the metal layer to obtain the connection line, processes of the display panel are greatly increased. Manufacturing efficiency of the display panel is affected and manufacturing costs increase.

With a continuous upgrade of liquid crystal panel technologies, small-sized panels, especially mobile phone panels of 4-7 inches, are gradually developed to be light and thin, and to have a high screen-to-body ratio, and an ultra-narrow bezel or even no bezel. In conventional LTPS panel technology, a size of a gate driver on array (GOA) is compressed, an IC chip using TDDI is equipped, and a distance between wires is reduced, so that a width of a bezel is already close to 0.5 mm. However, to ensure effective operation of a GOA circuit, a panel reliability test, and mutual separation of various signal lines, a conventional panel with side GOA is already approaching a limit especially a compression limit of a side bezel.

### Technical Problem

In the prior art, to ensure effective operation of a GOA circuit, reliability test of a panel, and mutual separation of various signal lines, a bezel cannot be narrower any more.

### SUMMARY OF INVENTION

The present invention provides a display panel including a display area, a non-display area surrounding the display area, multi-level GOA circuits, extension lines, multi-level signal scanning lines, an electrical insulation layer, and bridging lines. The multi-level GOA circuits are disposed in the non-display area, wherein each GOA circuit has a signal input end and a signal output end. The extension lines are located in the non-display area and respectively and correspondingly connected to the signal output ends of the GOA circuits. The multi-level signal scanning lines are disposed on a same layer as the extension lines and disposed in the display area, wherein each level of the signal scanning lines corresponds to one of the extension lines. The electrical insulation layer is covered the signal scanning lines and the extension lines. The bridging lines are disposed on the electrical insulation layer, and connected between at least one level of the signal scanning lines and one of the extension lines corresponding to the signal scanning line.

Further, the display panel includes through holes passed through the electrical insulation layer. The at least one level of signal scanning lines corresponds to one of the through holes, and one of the extension lines corresponding to the signal scanning line also corresponds to one of the through holes. The bridging line is connected between the at least one level of signal scanning lines and the extension line corresponding to the signal scanning line through one of the corresponding through hole.

Further, one level of the signal scanning lines closest to the multi-level GOA circuits and one of the extension lines corresponding to the signal scanning line are connected with each other on a same layer.

Further, the multi-level signal scanning lines are arranged in parallel, and are arranged from one side near the GOA circuits to another side away from the GOA circuits in the display area based on levels.

Further, the bridging lines located on the electrical insulation layer are perpendicular to the signal scanning lines, and form a grid structure with the signal scanning lines.

Further, a longitudinal direction of the signal scanning line is perpendicular to a longitudinal direction of the extension line.

Further, the bridging line is an indium tin oxide film.

Further, the extension line is a non-transparent metal wire.

Further, the display panel includes a drive chip, several data lines, and signal connection lines. The drive chip is disposed on one side of the non-display area away from the multi-level GOA circuits. The data lines are disposed in the display area and on an upper surface of the bridging lines and converged to the drive chip. The signal connection lines are disposed in the non-display area, wherein two ends of the signal connection line are respectively connected to an output end of the drive chip and an input end of the GOA circuit.

Beneficial Effect

According to the display panel and the display device in the present invention, a GOA circuit is disposed on an upper side of a display area, a signal scanning line in a direction X is connected to an extension line in a direction Y through a through hole by using a patterned bridging line. The bridging lines achieve electrical isolation by patterning to avoid a crosstalk between signals. The present invention is highly compatible with current processes without adding any additional photomask. An aperture ratio is not affected, additional parasitic capacitance is avoided. In such a structure, only a space between a signal line and a cutting line needs to be reserved on a side bezel, so that a width of the side bezel is reduced from 0.8 mm to 0.1-0.3 mm. Such a structure further coexists with a touch technology, to effectively implement an ultra-thin and narrow-bezel design in panel.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person skilled in the art may still derive other drawings from these accompanying drawings without creative efforts.

FIG. 1 is a schematic planar view of a display panel according to an embodiment.

FIG. 2 is a side view of a display panel according to an embodiment.

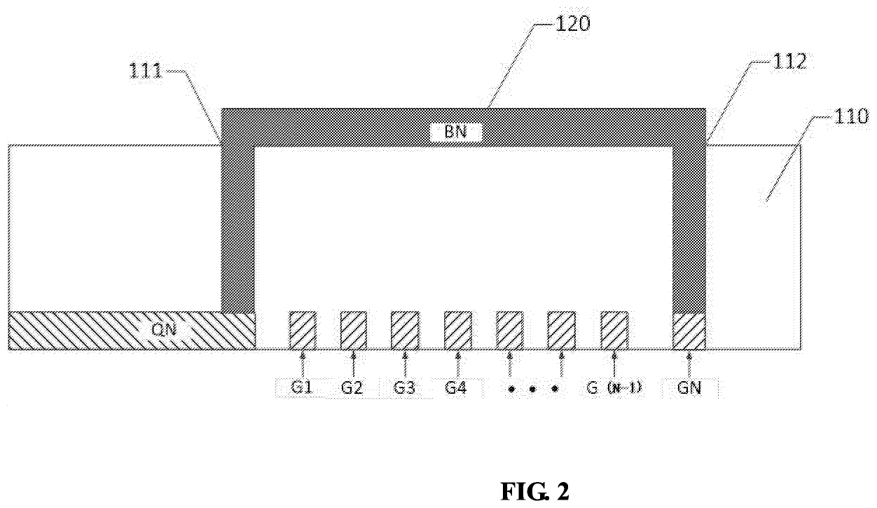

FIG. 3 is a schematic partial view of a display panel according to an embodiment.

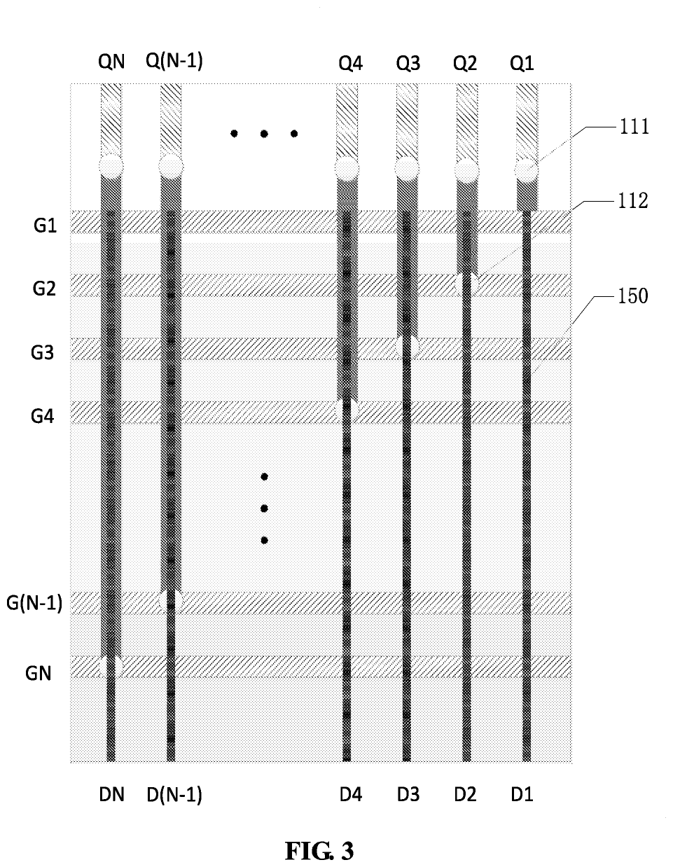

### REFERENCE NUMBERS IN THE DRAWINGS

10: Display panel;
101: Display area, 102: Non-display area;
1021: Multi-level GOA circuits, 1022: Drive chip;
1023: Control signal line;
110: Electrical insulation layer, 120: Bridging line;
130: Signal scanning line, 140: Extension line;
150: Data line; and
111: First through hole, and 112: Second through hole.

### DETAILED DESCRIPTION OF PREFERRED EMBODIMENTS

Preferred embodiments of the present invention are described in detail below with reference to the accompanying drawings in this specification, to completely describe technical content of the present invention to a person skilled in the art, to prove, by using an example, that the present invention can be implemented, so that the technical content disclosed in the present invention is clearer, and it is more easy for a person skilled in the art to understand how to implement the present invention. However, the present invention may be embodied by using many different forms of embodiments, the protection scope of the present invention are not limited to the embodiments mentioned in this specification, and descriptions of the following embodiments are not intended to limit the scope of the present invention.

Terms about directions mentioned in the present invention, such as “upper”, “lower”, “front”, “rear”, “left”, “right”, “in”, “out”, and “side surface” merely refer to directions in the accompanying drawings. The direction terms used in this specification are intended to explain and describe the present invention, but are not intended to limit the protection scope of the present invention.

In the accompanying drawings, components having a same structure are represented by a same numeral, and components having similar structures or functions are represented by similar numerals. In addition, for ease of understanding and description, a size and a thickness of each component shown in the accompanying drawings are arbitrarily shown, and the size and the thickness of each component are not limited in the present invention.

When some components are described to be “on” another component, the component may be directly disposed on another component; or there may be an intermediate component, the component is disposed on the intermediate component, and the intermediate component is disposed on the another component. When a component is described to be “installed on” or “connected to” another component, it may be understood that they are directly “installed” or “connected”, or a component is “installed on” or “connected to” another component by using an intermediate component.

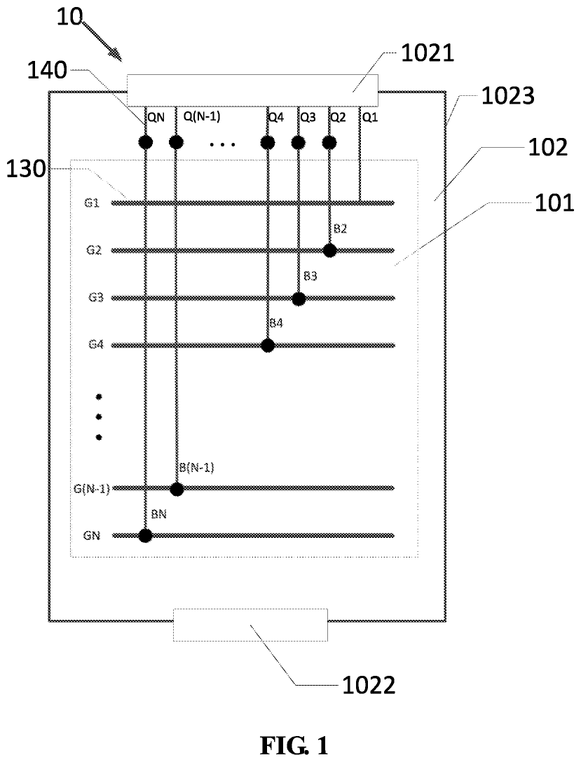

As shown in FIG. 1, in an embodiment, a display panel 10 in the present invention includes a display area 101, a non-display area 102 surrounding the display area 101, multi-level GOA circuits 1021, a drive chip 1022, control signal lines 1023, an electrical insulation layer 110, bridging lines 120, signal scanning lines 130, extension lines 140, and data lines 150.

The display area 101 include several signal scanning lines 130 arranged in parallel, and data lines 150 arranged in parallel. Referring to FIG. 1, the signal scanning lines 130 include metal wires G1 to GN. The data lines 150 include metal wires D1 to DN. The metal wires D1 to DN are distributed above the electrical insulation layer 110 and are correspondingly connected to the drive chip 1022.

The metal wires G1 to GN are respectively configured to connect to thin film transistors (not shown) in the display area 101. The data lines 150 is located above the signal scanning lines 130, is used as fan-out lines, and is connected to the drive chip 1022.

The multi-level GOA circuits 1021 is located in the non-display area 102 around the display area 101. In the present embodiment, the multi-level GOA circuits 1021 is located on one side of the display area 101. Each GOA circuit has a signal input end and a signal output end. The signal output end of each GOA circuit is correspondingly connected to one extension line, as shown in FIG. 1. The extension lines include non-transparent metal wires Q1 to QN. The extension lines 140 and the signal scanning lines 130 are disposed on a same layer. In the present embodiment, the metal wires G1 to GN are sequentially arranged from one side of the display area 101 near the multi-level GOA circuits 1021 to another side away from the GOA circuits 1021. The signal scanning line 130 is closest to the multi-level GOA circuits 1021. The metal wire Q1 of the extension lines 140 is directly connected to the metal wire G1 of the signal scanning lines 130.

The electrical insulation layer 110 covers all the metal wires G1 to GN of the signal scanning lines 130 and the metal wires Q1 to QN of the extension lines 140. Each first through hole 111 is passed through the electrical insulation layer 110 corresponding to one end of one of the metal wires Q2 to QN of the extension lines 140. Each second through hole 112 the electrical is passed through the insulation layer 110 corresponding to one end of one of the metal wires G2 to GN of the signal scanning lines 130. Similarly, connection lines between centers of the first through holes 111 corresponding to the metal wires Q3, Q4, . . . , Q(N−1), and QN and the second through holes 112 corresponding to the metal wires G3, G4, . . . , G(N−1), and GN are perpendicular to the signal scanning lines 130.

The bridging line 120 is an indium tin oxide film, and is disposed on the electrical insulation layer 110. The bridging line 120 includes bridging wires B2 to BN. One end of each of the bridging wires B2 to BN is connected to the one end of each of the metal wires Q2 to QN of the corresponding extension lines 140 through one of the first through holes 111. The other end of each of the bridging wires B2 to BN is connected to one of the metal wires G1 to GN of the corresponding signal scanning lines 130 through one of the second through holes 112.

In details, one end of the bridging wire B2 is electrically connected to the second signal metal wire G2 through the second through hole 112, and the other end of the bridging wire B2 is electrically connected to one end of the second metal wire Q2 through the first through hole 111. The metal wire Q2 and the metal wire G2 are located on a same layer. The bridging wire B2 is located on the electrical insulation layer 110 and is produced by photomask. In the prior art, there is a conductive film produced by photomask on an electrical insulation layer of a display panel. Therefore, in the present embodiment, the bridging wires B2 to BN are produced by photomask, without adding additional photomask, thereby reducing costs.

The third metal wire G3 is electrically connected to the bridging wire B3 through the second through hole 112. The bridging wire B3 is electrically connected to the second metal wire Q3 through the first through hole 111. The fourth metal wire G4 is electrically connected to the bridging wire B4 through the second through hole 112. The bridging wire B4 is electrically connected to the second metal wire Q4 through the first through hole 111. By analogy, the (N−1)^{th} metal wire G(N−1) is electrically connected to the bridging wire B(N−1) through the second through hole 112. The bridging wire B(N−1) is electrically connected to the second metal wire Q(N−1) through the first through hole 111. The N^{th} metal wire GN is electrically connected to the bridging wire BN through the second through hole 112. The bridging wire BN is electrically connected to the second metal wire QN through the first through hole 111. For details, refer to the second metal wire G2.

Several control signal lines 1023 are distributed in the non-display area 102 at two sides of the display area 101 of the display panel 10. The control signal lines 1023 are configured to transfer control signals output by drive chip 1022 to the signal input ends of the multi-level GOA circuits 1021.

The drive chip 1022 is disposed in the non-display area 102. The drive chip 1022 and the multi-level GOA circuits 1021 are separately located at two sides of the display area 101.

In the present embodiment, the display panel 10 in the present invention narrow left and right bezels of a liquid crystal panel, and in details, a width of the bezel may be 100 um to 300 um through the GOA circuit 1021 disposed in the non-display area 102, and the extension lines 140 connected to the signal scanning lines 130 by the corresponding bridging wires.

The present invention further provides a display device. A main improvement and a feature of the display device are both revealed by the display panel 10. For another component of the display device, details are not described one by one.

The terminal and the device provided in the present invention are described in detail above. It should be understood that, the exemplary implementations in this specification should be considered as merely for description, and are used to help understand the method and core ideas of the present invention rather than limit the present invention. Descriptions of a feature or an aspect in each exemplary implementation should be generally considered as a similar feature or aspect applicable to another exemplary embodiment. Although the present invention is described with reference to the exemplary embodiments, a person skilled in the art may be advised to make various changes and modifications. The present invention is intended to cover these changes and modifications falling within the scope of the appended claims.

The above descriptions are merely preferred embodiments of the present invention, but are not intended to limit the present invention. Any modification, equivalent replacement, and improvement made without departing from the spirit and principle of the present invention shall fall within the protection scope of the present invention.

What is claimed is:

1. A display panel, comprising:
a display area and a non-display area surrounding the display area;
multi-level gate driver on array (GOA) circuits disposed in the non-display area, wherein each GOA circuit comprises a signal input end and a signal output end;
extension lines located in the non-display area and respectively and correspondingly connected to the signal output ends of the GOA circuits;
multi-level signal scanning lines disposed on a same layer as the extension lines and disposed in the display area, wherein each level of signal scanning lines corresponds to one extension line;
an electrical insulation layer covered the signal scanning lines and the extension lines; and
bridging lines disposed on the electrical insulation layer, wherein one of the bridging lines connected between at least one level of signal scanning lines and one of the extension lines corresponding to the level of signal scanning line.

2. The display panel according to claim 1, further comprising
through holes passed through the electrical insulation layer, wherein the at least one level of signal scanning lines corresponds to one of the through holes, one of the extension line corresponding to the signal scanning line also corresponds to one of the through holes, and the bridging line is connected between the at least one level of signal scanning lines and the extension line corresponding to the signal scanning line through one of the corresponding through hole.

3. The display panel according to claim 1, wherein
the signal scanning line closest to the multi-level GOA circuits and one of the extension lines corresponding to the signal scanning line are connected with each other on a same layer.

4. The display panel according to claim 2, wherein
the multi-level signal scanning lines are arranged in parallel, and are arranged from one side near the GOA circuits to another side away from the GOA circuits in the display area based on levels.

5. The display panel according to claim 1, wherein
the bridging lines located on the electrical insulation layer are perpendicular to the signal scanning lines, and form a grid structure with the signal scanning lines.

6. The display panel according to claim 1, wherein a longitudinal direction of the signal scanning line is perpendicular to a longitudinal direction of the extension line.

7. The display panel according to claim 1, wherein
the bridging line is an indium tin oxide film.

8. The display panel according to claim 1, wherein
the extension line is a non-transparent metal wire.

9. The display panel according to claim 1, further comprising:
a drive chip disposed on one side of the non-display area away from the multi-level GOA circuits;
several data lines disposed in the display area and on an upper surface of the bridging lines and converged to the drive chip; and
signal connection lines disposed in the non-display area, wherein two ends of the signal connection line are respectively connected to an output end of the drive chip and an input end of the GOA circuit.

10. A display device, comprising the display panel according to claim 1.

11. A display device, comprising the display panel according to claim 2.

12. A display device, comprising the display panel according to claim 3.

13. A display device, comprising the display panel according to claim 4.

14. A display device, comprising the display panel according to claim 5.

15. A display device, comprising the display panel according to claim 6.

16. A display device, comprising the display panel according to claim 7.

17. A display device, comprising the display panel according to claim 8.

18. A display device, comprising the display panel according to claim 9.
